(19) United States
(12) Patent Application Publication
(10) Pub. No.: US 2015/0134637 A1
(43) Pub. Date: May 14, 2015

(54) System and Method for Sharding a Graph Database

(71) Applicant: INMOBI PTE. LTD., Singapore (SG)

(72) Inventors: Inderbir Singh Pall, Bangalore (IN); Srikanth Sundarrajan, Chennai (IN)

(73) Assignee: INMOBI PTE. LTD., Singapore (SG)

(21) Appl. No.: 14/539,362

(22) Filed: Nov. 12, 2014

(30) Foreign Application Priority Data
Nov. 12, 2013 (IN) 5115/CHE/2013

(51) Int. Cl. G06F 17/30

(52) U.S. Cl. CPC G06F 17/3048; G06F 17/30958
USPC 707/718; 707/798

(57) ABSTRACT

The present invention provides a method and system for sharding a graph database. The graph computing includes one or more processors, and a memory module. The memory module contains instructions that, when executed by the one or more processors, causes the one or more processors to perform a set of steps including identifying a first set of nodes from a plurality of nodes and a second set of nodes from a plurality of nodes, generating one or more sub graph shards from the graph database, and storing the one or more sub graph shards on one or more data stores. Each sub graph shard of the one or more sub graph shards includes at least one node from the first set of nodes and a replica of the second set of nodes.

### FIELD OF INVENTION

The present invention relates to graph databases and in particular, it relates to sharding and querying of graph databases.

### BACKGROUND

Recent technological and scientific advances have resulted in abundance of large-scale data. To handle this data explosion, various models have been suggesting for storing and mining the large-scale data. One such model is graph data model. Graph data models have been utilized in database systems for semantic data modeling, large-scale data storage, etc. In context of a database system, a graph database refers to a collection of data that is stored in a graph data structure implemented in the database system. The graph database includes a graph, the graph having one or more nodes (or vertices) that are connected by one or more edges (or links). Each node has a type or class and at least one value associated with it. The edges indicate the relationship between the nodes.

Queries over the graph database are accomplished by traversing the nodes of the graph. Traversing is performed to identify a sub-graph pattern and subsequently project desired values out from the matched pattern for the result. However, when the graph database has nodes in the range of millions, traversing operation is generally time-consuming. Moreover, storing the graph database becomes difficult, due to the high number of nodes. Additionally, the possibility of a supernode in the graph increases when there are a lot of nodes. A supernode is a node with a disproportionately high number of incident edges. Presence of supernodes often results in performance problems and particularly retards the scalability of the graph database.

Various attempts have been made to solve the above-mentioned problems. One attempt (described in US 20120173541, Venkataramani) utilizes a distributed cache system. The distributed cache system contains a set of cache nodes, each cache node having a part of the graph database. However, the distributed cache system suffers from problems common to a caching system. For example, in the caching system, caching policy of the system determines the efficiency of the system and therefore, a poor caching policy often results in poor efficiency. This is particularly relevant in graph database as the graph database has a flexible schema and caching policies are not suitable for flexible schema. Additionally, since caches are limited in memory, therefore data that can be stored in caches is limited too.

Another attempt utilizes indices to find and aggregate simple pattern matches that can be combined to generate complex query pattern results. However, this attempt is difficult to scale and must be performed largely in serial. Therefore, this attempt does not work well when the graph databases has a lot of nodes.

In light of the above discussion, there is a need for a method and system which overcomes all the above stated problems.

### BRIEF DESCRIPTION OF THE INVENTION

The above-mentioned shortcomings, disadvantages and problems are addressed herein which will be understood by reading and understanding the following specification.

In embodiments, the present invention provides a graph computing system for sharding a graph database. The graph database includes a plurality of nodes and a plurality of edges. The graph computing system includes one or more processors, and a memory module. The memory module contains instructions that, when executed by the one or more processors, causes the one or more processors to perform a set of steps including identifying a first set of nodes from the plurality of nodes and a second set of nodes from the plurality of nodes, generating one or more sub graph shards from the graph database, and storing the one or more sub graph shards on one or more data stores.

Each node of the first set of nodes is connected, by two or more outgoing edges from the plurality of edges, to two or more nodes from the second set of nodes, and is disconnected from each node of the first set of nodes. Each sub graph shard of the one or more sub graph shards includes at least one node from the first set of nodes and a replica of the second set of nodes.

In an embodiment, the one or more processors are further configured to perform a set of steps including generating one or more identifiers for the one or more sub graph shards, and storing the one or more identifiers in a registry.

In an embodiment, the one or more processors are further configured to perform a set of steps including receiving a database query, and executing the database query on the one or more sub graph shards. The database query is based on a set of attributes.

In another aspect, the present invention provides a computer implemented method for sharding a graph database using the graph computing system. The computer implemented method includes identifying, by the graph computing system, a first set of nodes from the plurality of nodes and a second set of nodes from the plurality of nodes, generating, by the graph computing system, one or more sub graph shards from the graph database, and storing, by the graph computing system, the one or more sub graph shards on one or more data stores.

In an embodiment, the computer implemented method further includes generating, by the graph computing system, one or more identifiers for the one or more sub graph shards, and storing, by the graph computing system, the one or more identifiers in a registry.

In an embodiment, the computer implemented method further includes receiving, by the graph computing system, a database query, and executing, by the graph computing system, the query on the one or more sub graph shards.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 illustrates a computing system for sharding a graph database, in accordance with various embodiments of the present invention;

FIG. 2 illustrates a flowchart for sharding the graph database, in accordance with various embodiments of the present invention;

FIG. 3 illustrates an exemplary graph database, in accordance with various embodiments of the present invention; and

FIG. 4 illustrates two exemplary sub graph shards, in accordance with various embodiments of the present invention; and

FIG. 5 illustrates a block diagram of a graph computing system, in accordance with various embodiments of the present invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

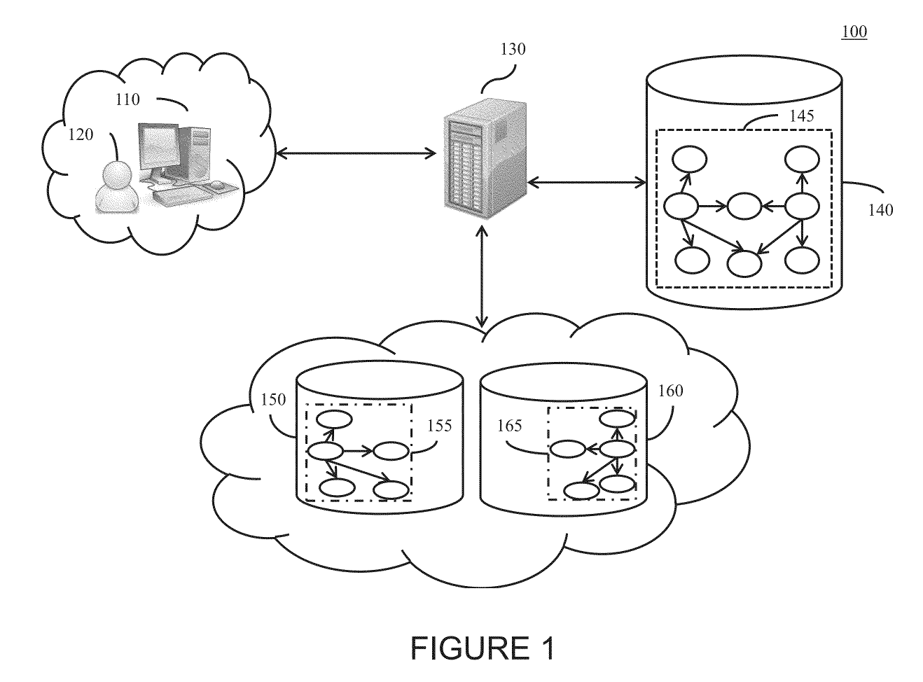

FIG. 1 illustrates a computing system 100 for sharding a graph database 145, in accordance with various embodiments of the present invention.

The computing system 100 includes a user terminal 110. In context of the present invention, the user terminal 110 refers to a workstation or a terminal used by a user 120. The user terminal 110 allows the user 120 to assign tasks to a graph computing system 130. In an embodiment, the user terminal 110 allows the user 120 to initiate sharding of the graph database 145. In another embodiment, the user terminal 110 allows the user 120 to enter a database query to be run on the graph database 145.

The computing system 100 includes a data store 140. The graph database 145 is stored in the data store 140. In context of the present invention, graph database 145 refers to a collection of data that is stored in a graph data structure implemented in the data store 140. The graph database includes a plurality of nodes that are connected by a plurality of edges. For example, the graph database 145 has data relating to advertisements and advertisement analytics. The graph database 145 contains nodes for users, advertisements, devices of the users, locations where the users live, etc. Edges connect nodes, having user information, with the various other nodes associated with the users, and are labeled with labels to indicate the nature of the relationship. For example, node ‘user XYZ’ is connected to node ‘location 1: Delhi’ with an outgoing edge labeled with the label ‘lives’. Since the edge goes out from the node ‘user XYZ’ to node ‘location 1: Delhi’, the edge is termed as an outgoing edge.

The graph computing system 130 receives commands and queries from the user terminal 110. On receiving a command to shard the graph database 145, the graph computing system 130 retrieves the graph database 145 from the data store 140 and shards the graph database 145 into one or more sub graph shards. For example, as shown in FIG. 1, the graph computing system 130 shards the graph database 145 into sub graph shards 155 and 165. In an embodiment, the graph computing system 130 stores the one or more shards on one or more data stores. For example, as shown in FIG. 1, the graph computing system stores the sub graph shards 155 and 165 on data store 150 and data store 160 respectively.

In an embodiment, the graph computing system 130 receives database queries from the user terminal 110. Accordingly, the graph computing system 130 executes the queries on the one or more sub graph shards (shown in FIG. 1 as the sub graph shard 155 and the sub graph shard 165).

It will be appreciated by the persons skilled in the art, that while FIG. 1, shows the graph computing system 130 as a single computing device, the graph management system 130 can include multiple computing devices connected together. Moreover, it will be appreciated that while FIG. 1 shows two sub graph shards 155 and 165 stored on data stores 150 and 160, there can be one or more sub graph shards stored on one or more data stores.

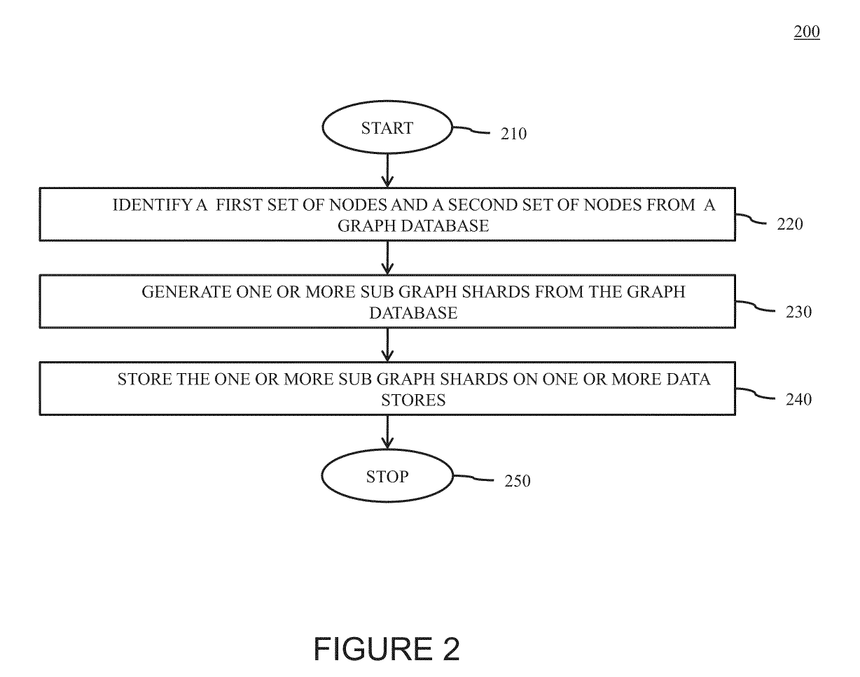

FIG. 2 illustrates a flowchart 200 for sharding the graph database, in accordance with various embodiments of the present invention. At step 210, the flowchart 200 initiates. At step 220, the graph computing system 130 identifies a first set of nodes from the plurality of nodes and a second set of nodes from the plurality of nodes.

The graph computing system 130 identifies the first set of nodes and the second set of nodes on the basis of properties of the nodes. The graph computing system 130 classifies a node as a node of the first set if the node is not connected to any other node of the same type and if the node has outgoing edges from the node to other nodes to which the node is connected. All nodes which qualify the two conditions are classified as the first set of nodes. The remaining nodes are classified as the second set of nodes.

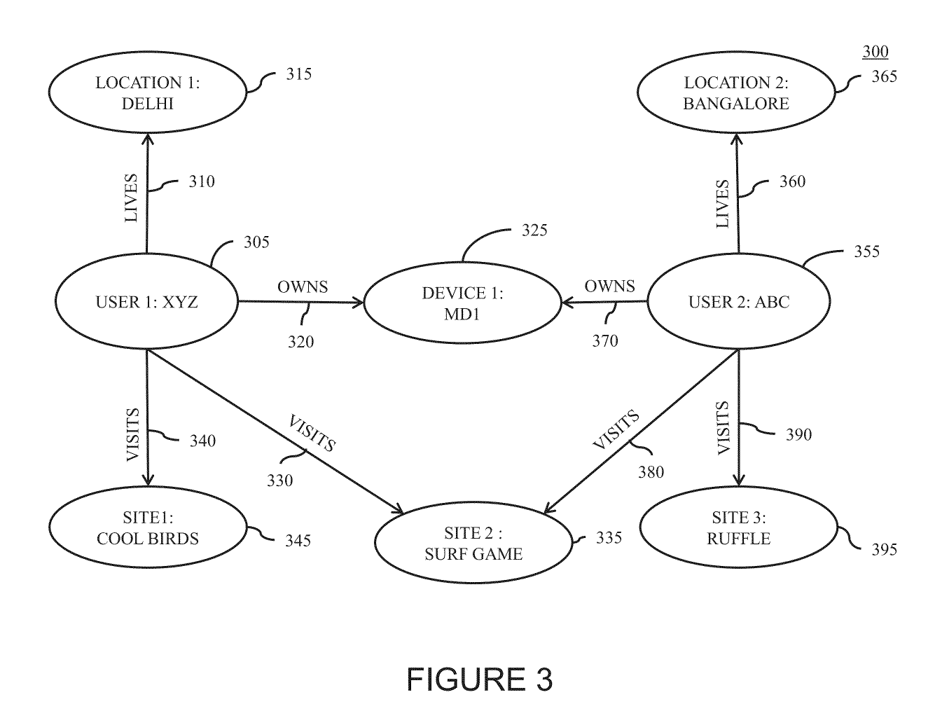

For example, as further described in FIG. 3, the graph database 145 contains eight nodes and eight edges. From the eight nodes, the graph database 145 two user nodes (user 1:XYZ and user 2:ABC), one device node (device 1:MD1), two location nodes (location 1:Delhi and location 2:Bangalore), three site nodes (site 1:cool birds, site 2:surf game, and site 3:ruffle). Of the above mentioned two conditions, the first condition that a node should be disconnected from another node of the same type as the node is satisfied by all the eight nodes. However, the second condition that the node should be connected to two or more nodes by outgoing edges is only satisfied by the two user nodes. Therefore, the graph computing system 130 will classify the two user nodes as the first set of nodes and all the other nodes as the second set of nodes.

At step 230, the graph computing system 130 generates one or more sub graph shards from the graph database 145. Each sub graph shard of the one or more sub graph shards comprises at least one node from the first set of nodes and a replica of the second set of nodes.

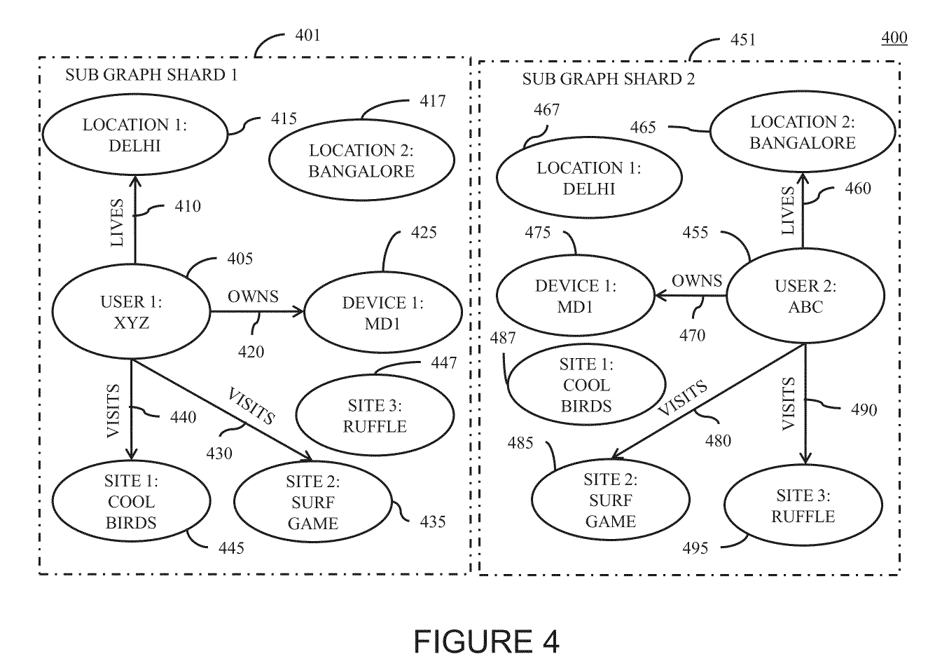

For example, as further described in FIG. 4, the graph computing system 130 generates two sub graph shards: the sub graph shard 155 and the sub graph shard 165. The graph computing system 130 creates the sub graph shards 155 and 165 using the first set of nodes and the second set of nodes. The graph computing system creates the sub graph shard 155 using the user node user 1:XYZ and all the nodes of the second set. The sub graph shard 155 resembles a hub and spoke data model in which the user node user 1:XYZ is hub node and the other nodes are spoke nodes centered around the hub node. In a similar manner, the graph computing system 130 generates the sub graph shard 165.

While the above mentioned example mentions the one or more sub graph shards (155 and 165) have one node of the first set of nodes each, it is to be noted that there can be more than one node from the first set of nodes in each sub graph shards. The number of nodes of the first set of nodes to be included in each sub graph shard of the one or more sub graph shards is determined as per a partitioning policy set in the graph computing system 130. In an embodiment, the graph computing system 130 includes a predetermined number of nodes of the first set of nodes in each sub shard. For example, the graph computing system 130 includes three nodes from the first set of nodes in each sub graph shard. In another embodiment, the graph computing system utilizes a min cut algorithm to determine the optimal number of nodes from the first set of nodes to be included in each sub graph shard. In yet another embodiment, the graph computing system 130 randomly assigns nodes from the first set of nodes to each sub graph shard.

At step 240, the graph computing system 130 stores the one or more sub graph shards in one or more data stores. For example, as shown in FIG. 1, the graph computing system 130 stores the sub graph shard 155 and the sub graph shard 165 on data store 150 and data store 160 respectively.

In an embodiment, the graph computing system 130 generates one or more identifiers for the one or more sub graph shards. An identifier from the one or more identifiers is associated with a sub graph shard from the one or more sub graph shards. The one or more identifiers are used for identifying the one or more sub graph shards. Accordingly, the graph computing system 130 stores the one or more identifiers in a registry. In an embodiment, the registry includes details of the nodes from the first set of nodes present in a particular sub graph shard along with associated identifier of the particular sub graph shard.

In an embodiment, the graph computing system 130 receives a database query. The database query is based on a set of attributes. Then, the graph computing system 130 executes the query on the one or more sub graph shards. In an embodiment, the graph computing system 130 analyses the database query to determine whether the set of attributes is related to the first set of nodes or the second set of nodes. If the set of attributes is related to the first set of nodes, the graph computing system 130 utilizes the registry to break the database query into independent queries and executes the independent queries on the one or more sub graph shards. Since the one or more sub graph shards are share nothing in design, independent queries are executed independently. By doing so, the graph computing system 130 exploits data parallelism present in the graph database 145.

At step 250, the flowchart terminates. It will be appreciated by persons skilled in the art that while FIG. 2 shows the flowchart 200 as having five steps (210-250); the flowchart 200 can include additional steps for optimizing the sharding of the graph database 145.

FIG. 3 illustrates an exemplary graph database 300, in accordance with various embodiments of the present invention. The graph database 300 contains eight nodes and eight edges. From the eight nodes, the graph database 145 two user nodes (user 1:XYZ 305 and user 2:ABC 355), one device node (device 1:MD1 325), two location nodes (location 1:Delhi 315 and location 2:Bangalore 365), three site nodes (site 1:cool birds 345, site 2:surf game 335, and site 3:ruffle 395). User node user 1:XYZ 305 is connected to device node device 1:MD1 325 using outgoing edge 320, location node location 1:Delhi 315 using outgoing edge 310, and site nodes site 1:cool birds 345 and site 2:surf game 335 using outgoing edges 340 and 330 respectively. User node user 2:ABC 355 is connected to device node device 1:MD1 325 using outgoing edge 370, location node location 2:Bangalore 365 using outgoing edge 360, and site nodes site 2:surf game 335 and site 3:ruffle 395 using outgoing edges 380 and 390 respectively. All the edges are labeled with labels to indicate the relationship between the nodes connected.

FIG. 4 illustrates two exemplary sub graph shards 401 and 451, in accordance with various embodiments of the present invention. Sub graph shard 401 contains seven nodes and four edges. As explained above, user node user 1:XYZ 405 is from the first set of nodes and the remaining nodes are from the second set of nodes. Similarly, sub graph shard 451 contains seven nodes and four edges. As explained above, user node user 2:ABC 455 is from the first set of nodes and the remaining nodes are from the second set of nodes.

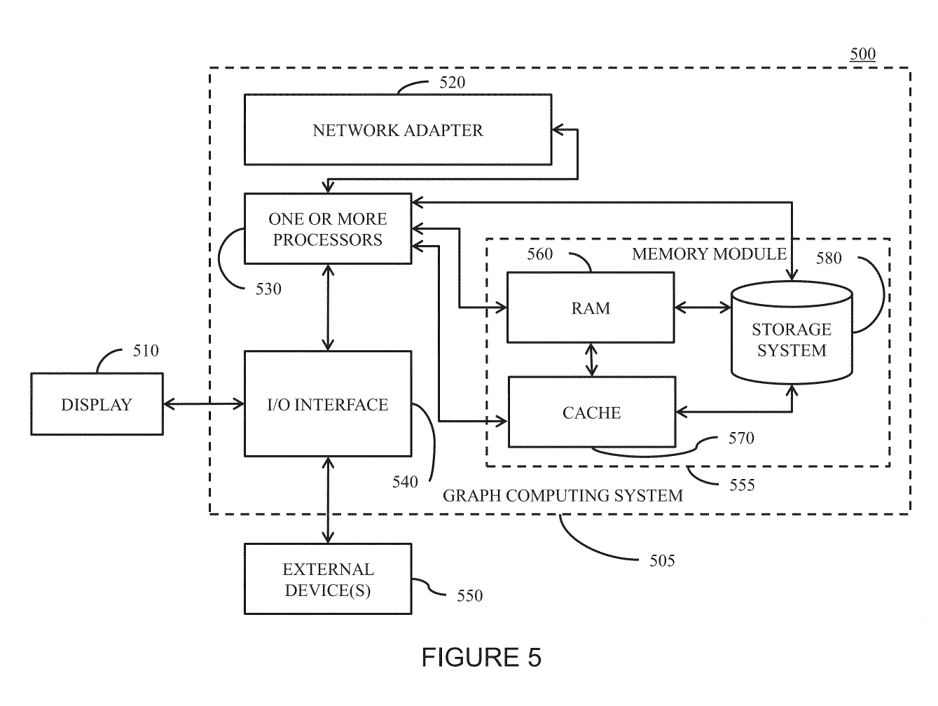

FIG. 5 illustrates a block diagram of a graph computing system 500. The components of the graph computing system 500 include, but are not limited to, one or more processors 530, a memory module 555, a network adapter 520, a input-output (I/O) interface 540 and one or more buses that couples various system components to one or more processors 530.

The one or more buses represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The graph computing system 500 typically includes a variety of computer system readable media. Such media may be any available media that is accessible by the graph computing system 500, and includes both volatile and non-volatile media, removable and non-removable media. In an embodiment, the memory module 555 includes computer system readable media in the form of volatile memory, such as random access memory (RAM) 560 and cache memory 570. The graph computing system 500 may further include other removable/non-removable, non-volatile computer system storage media. In an embodiment, the memory module 555 includes a storage system 580.

The graph computing system 500 can communicate with one or more external devices 550 and a display 510, via input-output (I/O) interfaces 540. In addition, the graph computing system 500 can communicate with one or more networks such as a local area network (LAN), a general wide area network (WAN), and/or a public network (for example, the Internet) via the network adapter 520.

It can be understood by one skilled in the art that although not shown, other hardware and/or software components can be used in conjunction with the the graph computing system 500. Examples, include, but are not limited to: microcode, device drivers, redundant processing units, external disk drive arrays, RAID systems, tape drives, and data archival storage systems, etc.

Configuration and capabilities of the the graph computing system 130 is same as configuration and capabilities of the the graph computing system 500.

As will be appreciated by one skilled in the art, aspects can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. The computer readable medium can be a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium can be any tangible medium that can contain, or store a program for use by or in connection with an instruction execution system, apparatus, or device.

Computer program code for carrying out operations for aspects of the present invention can be written in any combination of one or more programming languages, including an object oriented programming language and conventional procedural programming languages.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A graph computing system for sharding a graph database, wherein the graph database comprises a plurality of nodes and a plurality of edges, the graph computing system comprising:
one or more processors; and
a memory module containing instructions that, when executed by the one or more processors, causes the one or more processors to perform a set of steps comprising:
identifying a first set of nodes from the plurality of nodes and a second set of nodes from the plurality of nodes, wherein each node of the first set of nodes is connected, by two or more outgoing edges from the plurality of edges, to two or more nodes from the second set of nodes, and wherein each node of the first set of nodes is disconnected from each node of the first set of nodes;
generating one or more sub graph shards from the graph database, wherein each sub graph shard of the one or more sub graph shards comprises at least one node from the first set of nodes and a replica of the second set of nodes; and
storing the one or more sub graph shards on one or more data stores.

2. The graph computing system as claimed in claim 1, wherein the one or more processors are further configured to perform a set of steps comprising:
generating one or more identifiers for the one or more sub graph shards, wherein an identifier from the one or more identifiers is associated with a sub graph shard from the one or more sub graph shards; and
storing the one or more identifiers in a registry.

3. The graph computing system as claimed in claim 1, wherein the one or more processors are further configured to perform a set of steps comprising:
receiving a database query, wherein the database query is based on a set of attributes; and
executing the database query on the one or more sub graph shards.

4. A computer implemented method for sharding a graph database using a graph computing system, wherein the graph database comprises a plurality of nodes and a plurality of edges, the computer implemented method comprising:
identifying, by the graph computing system, a first set of nodes from the plurality of nodes and a second set of nodes from the plurality of nodes, wherein each node of the first set of nodes is connected, by two or more outgoing edges from the set of edges, to two or more nodes from the second set of nodes, and wherein each node of the first set of nodes is disconnected from each node of the first set of nodes;
generating, by the graph computing system, one or more sub graph shards from the graph database, wherein each sub graph shard comprises at least one node from the first set of nodes and a replica of the second set of nodes; and
storing, by the graph computing system, the one or more sub graph shards on one or more data stores.

5. The computer implemented method as claimed in claim 4, wherein the computer implemented method further comprises:
generating, by the graph computing system, one or more identifiers for the one or more sub graph shards, wherein an identifier from the one or more identifiers is associated with a sub graph shard from the one or more sub graph shards; and
storing, by the graph computing system, the one or more identifiers in a registry.

6. The computer implemented method as claimed in claim 4, wherein the computer implemented method further comprises
receiving, by the graph computing system, a database query, wherein the database query is based on a set of attributes; and
executing, by the graph computing system, the query on the one or more sub graph shards.
